(19) United States
(12) Patent Application Publication
(10) Pub. No.: US 2015/0377414 A1
(43) Pub. Date: Dec. 31, 2015

(54) MODULAR FRAME ASSEMBLY

(71) Applicant: Alex Parsa Pirseyedi, Toronto (CA)

(72) Inventor: Alex Parsa Pirseyedi, Toronto (CA)

(21) Appl. No.: 14/752,645

(22) Filed: Jun. 26, 2015

Related U.S. Application Data
(60) Provisional application No. 62/017,731, filed on Jun. 26, 2014.

(51) Int. Cl. F16S 3/08; F16B 21/09

(52) U.S. Cl. CPC F16S 3/08; F16B 21/09

(57) ABSTRACT

A modular frame assembly comprises a first frame member, a second frame member, and a node. The first frame member is connected to the node by a first connector. The second frame member is connected to the node by a second connector. There may be a third frame member connected to the node by a third connector. The first frame member may be aligned along an x-axis. The second frame member may be aligned along a y-axis. The third frame member may be aligned along a z-axis.

### BACKGROUND OF THE INVENTION

1. Field of the Invention

The present invention relates to a modular frame assembly and, in particular, to a modular frame assembly comprising a universal node.

2. Description of the Related Art

U.S. Pat. No. 8,065,847 issued on Nov. 29, 2011 to Gimpel et al. and discloses a modular frame assembly. The frame assembly comprises a plurality of support members and an axial connection. The support members include opposing ends and a body portion. The support members each have an exterior channel and a central bore. The channel defines a flange portion and the bore is in communication with a retention feature. The axial connection is configured to releasably couple an end of a first support member to an end of a second support member such that the two support members are axially aligned. The axial connection includes a collar which is releasably coupled in the bore of each member. Each collar includes at least one locator portion to interact with the retention feature and a pin. The pin has a mid-portion and two ends. The mid-portion of the pin is configured to be rotatably selectively restrained within the collar.

### SUMMARY OF THE INVENTION

There is provided a modular framing assembly comprising a first frame member, a second frame member, and a node. The first frame member is connected to the node by a first connector. The second frame member is connected to the node by a second connector. There may be a third frame member connected to the node by a third connector. The first frame member may be aligned along an x-axis. The second frame member may be aligned along a y-axis. The third frame member may be aligned along a z-axis. The first frame member, the second frame member, and the third frame member may each be an elongate frame member.

There is also provided a modular frame assembly comprising a first component, a second component, and a third component. A first connector connects the first component to the second component such that relative rotation of the first component and the second component as well as relative movement of the first component and the second component along an x-axis, a y-axis and a z-axis is restricted. A second connector connects the second component to the third component such that relative rotation of the second component and the third component as well as relative movement of the second component and the third component along an x-axis, a y-axis and a z-axis is restricted. The first connector and second connector may be identical and interchangeable. The first component, the second component, and the third component may be unique.

There is further provided a modular frame assembly comprising, a first component, a second component, and a third component. A first connector connects the first component to the third component such that relative rotation of the first component and the third component as well as relative movement of the first component and the third component along an x-axis, a y-axis and a z-axis is restricted. A second connector connects the second component to the third component such that relative rotation of the second component and the third component as well as relative movement of the second component and the third component along an x-axis, a y-axis and a z-axis is restricted. The first connector and second connector may be identical and interchangeable. The first component, the second component, and the third component may be unique.

The connectors are received by a recess and relative rotation of the connectors is restricted by one or more sides of the connectors pushing against one or more inner walls of the recess.

### BRIEF DESCRIPTIONS OF DRAWINGS

The invention will be more readily understood from the following description of the embodiments thereof given, by way of example only, with reference to the accompanying drawings, in which:

FIG. 1 is a perspective view of a frame member, a connector, and a node of a modular frame assembly;

FIG. 2 is a perspective view showing the connector of FIG. 1 used to connect the frame member and the node of FIG. 1;

FIG. 3 is an exploded view of a three-way joint of the modular frame assembly including the frame member, the connector, and the node of FIG. 1;

FIG. 4 is a perspective view of the assembled three-way joint of FIG. 3;

FIG. 5 is a perspective view of the connector of FIG. 1;

FIG. 6 is a top plan view of the connector of FIG. 1;

FIG. 7 is a side elevation view of the connector of FIG. 1;

FIG. 8 is a perspective view of the node of FIG. 1;

FIG. 9 is a top plan view of the node of FIG. 1;

FIG. 10 is a cross-sectional view of the node taken along lines A-A of FIG. 9;

FIG. 11 is a top plan view showing the connector of FIG. 1 connected to the node of FIG. 1;

FIG. 12 is a cross-sectional view taken along lines B-B of FIG. 11;

FIG. 13 is an elevation view of the frame member of FIG. 1;

FIG. 14 is a cross-sectional view taken along lines C-C of FIG. 13;

FIG. 15 is a cross-sectional view taken along lines D-D of FIG. 13; and

FIG. 16 is a perspective view of a plurality of frame members including the frame member of FIG. 1;

FIG. 17 is a perspective view of the node, the connector, and a hinge member of the modular frame assembly;

FIG. 18 is a perspective view showing the connector of FIG. 17 used to connect the node and the hinge member of FIG. 17;

FIG. 19 is a perspective view of a driver of the modular frame assembly;

FIG. 20 is an exploded view of the driver of FIG. 19;

FIG. 21 is perspective view of another adapter coupled to the driver of FIG. 19;

FIG. 22 is perspective view of a pulley coupled to the driver of FIG. 19;

FIG. 23 is a perspective view of a frame member, a connector, and a node of another modular frame assembly;

FIG. 24 is a perspective view showing the connector of FIG. 23 used to connect the frame member and the node of FIG. 23;

FIG. 25 is a perspective, sectional view showing the connector of FIG. 23 used to connect the frame member and the node of FIG. 23;

FIG. 26 is a perspective view of the node of FIG. 23;

FIG. 27 is a perspective, sectional view of the node of FIG. 23;

FIG. 28 is a top plan view of the node of FIG. 23;

FIG. 29 is a cross-sectional view of the node taken along lines E-E of FIG. 28;

FIG. 30 is a perspective view of a frame member, a connector, and a node of another modular frame assembly;

FIG. 31 is a perspective view showing the connector of FIG. 30 used to connect the frame member and the node of FIG. 30;

FIG. 32 is a perspective, sectional view showing the connector of FIG. 30 used to connect the frame member and the node of FIG. 30;

FIG. 33 is a perspective view of the node of FIG. 30;

FIG. 34 is a perspective, sectional view of the node of FIG. 30;

FIG. 35 is a top plan view of the node of FIG. 30;

FIG. 36 is a cross-sectional view of the node taken along lines F-F of FIG. 35.

### DESCRIPTIONS OF THE PREFERRED EMBODIMENTS

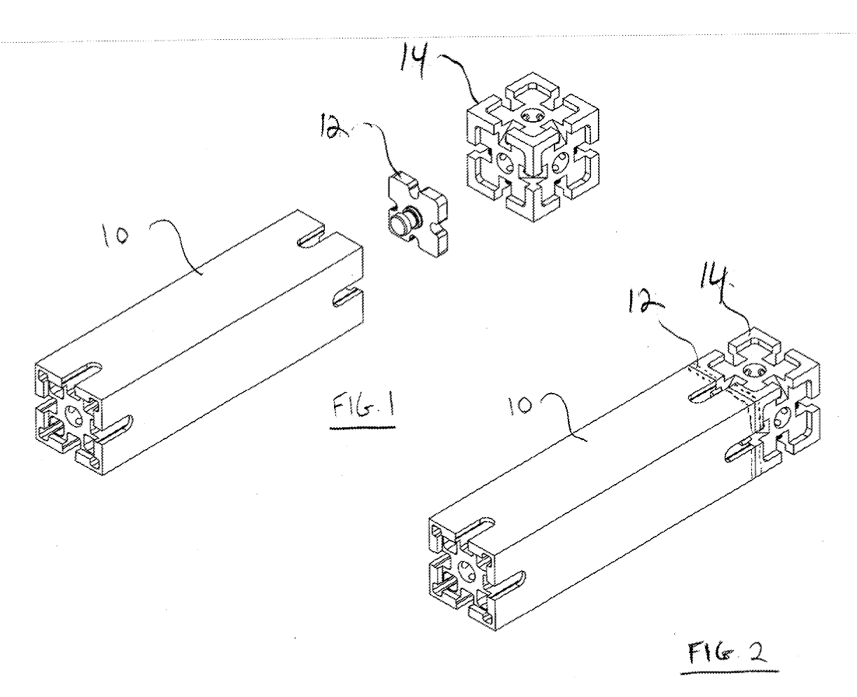

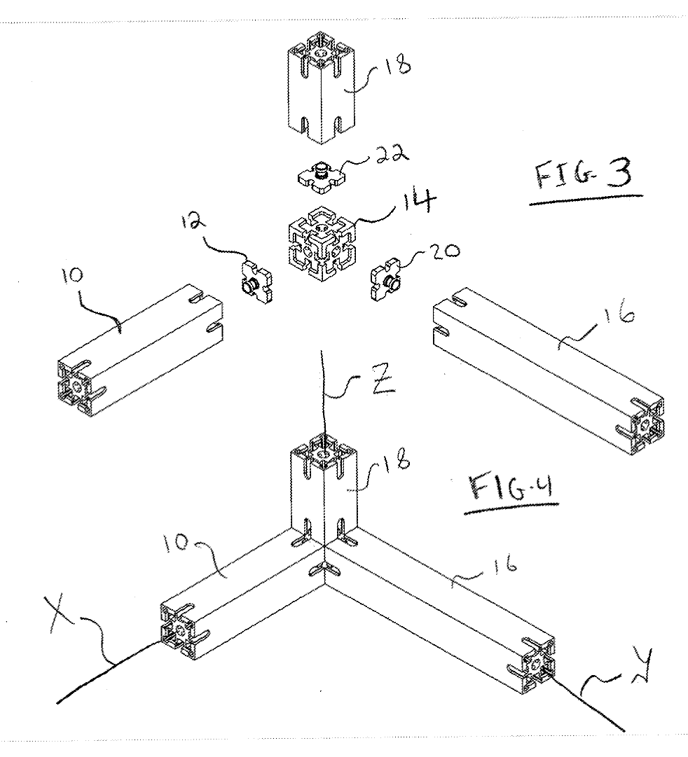

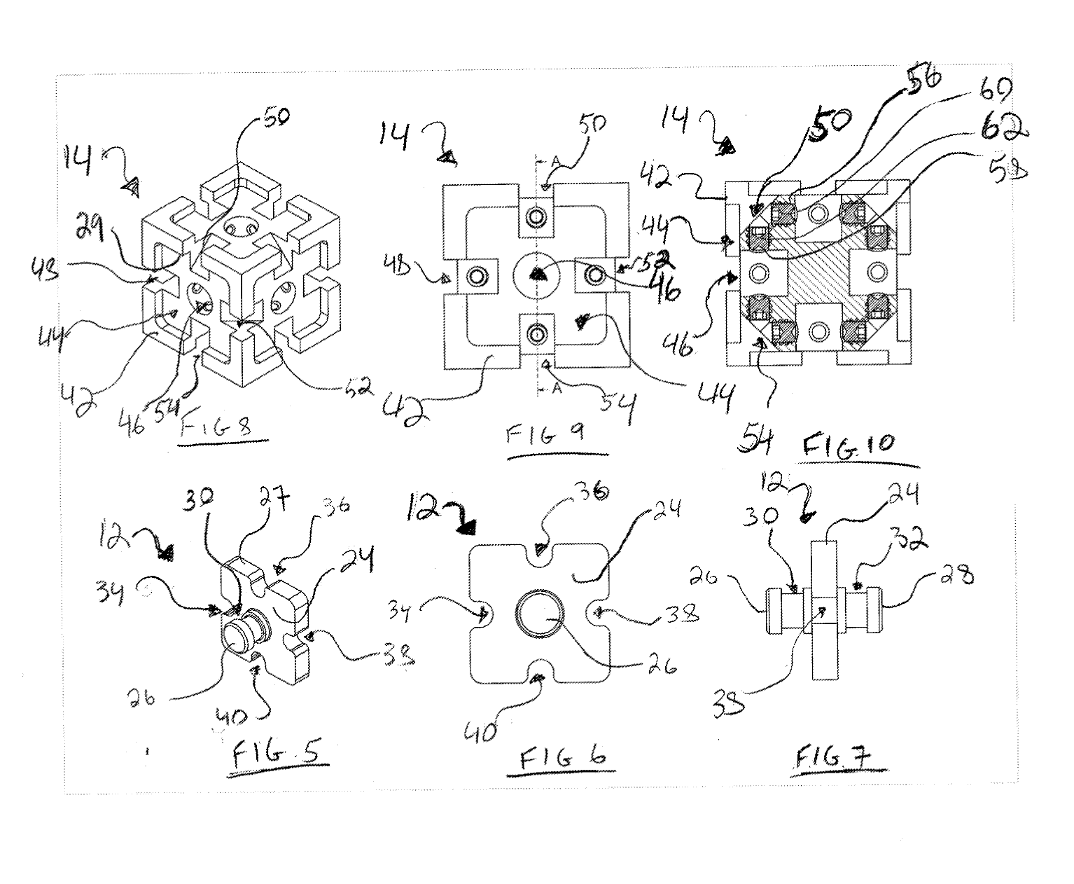

Referring to the drawings and first to FIG. 1, various components of a modular frame assembly are shown. The components shown include a first frame member 10, a first connector 12, and a node 14. The first connector 12 is used to releasably connect the first frame member 10 to the node 14 as shown in FIG. 2. Referring now to FIGS. 3 and 4, a second frame member 16 and a third frame member 18 may also be releasably connected to the node 14 to form, for example, a three-way corner. The second frame member 16 is connected to the node 14 by a second connector 20 and the third frame member 18 is connected to the node 14 by a third connector 22. The first frame member 10 is aligned along an x-axis. The second frame member 16 is aligned along a y-axis. The third frame member 18 is aligned along a z-axis. In this example, the frame members are elongate frame members. However, in other examples, the frame members may be any suitable shape.

The connector 12 is shown in greater detail in FIGS. 5 to 7. The connector 12 includes a plate 24 with symmetrical projections 26 and 28 extending from each side thereof. The symmetrical projections 26 and 28 are each provided with a corresponding annular recess 30 and 32. There are also spaced-apart recesses 34, 36, 38, and 40 disposed about a perimeter of the plate 24. In this example, the plate 24 is quadrilateral and the recesses 34, 36, 38, and 40 are each disposed on a respective edge of the plate. It will be understood by a person skilled in the art that the second connector 20 and the third connector 22 have a substantially similar structure and function in a substantially similar manner.

The node 14 is shown in greater detail in FIGS. 8 to 10 and, in this example, is generally cuboid in shape. The node 14 has six substantially identical sides of which one side 42 is best shown. The side 42 has a recess 44 which is configured to receive the plate 24 of the connector 12 which is shown in FIGS. 5 to 7. Referring back to FIGS. 8 to 10, there is also a bore 46 disposed in the center of the recess 44 and chamfers 48, 50, 52 and 54 on each edge of the side 42. It will be understood by a person skilled in the art that the other sides of the node 14 each have a substantially similar structure and function in a substantially similar manner.

There is a pair of threaded apertures on each chamfer, for example, threaded apertures 56 and 58 as shown in FIG. 10 for one of the chamfers 50. The threaded apertures extend through to corresponding bores on the respective sides of the node 14 as shown, for example, in FIG. 10 in which the threaded aperture 58 extends through the chamfer 50 to the bore 46. There is a set screw in each of the apertures. FIG. 10 shows set screw 60 in the threaded aperture 56 and a set screw 62 in the threaded aperture 58.

Referring now to FIGS. 11 and 12, the connector 12 is shown connected to the node 14. The connector 12 is received by the recess 44 in the node 14 with the recesses 34, 36, 38, and 40 in the connector aligned with the chamfers 48, 50, 52 and 54 in the node. The projection 28 of the connector 12 is received by the bore 46 in the node 14 and the set screw 62 is adjusted to engage the recess 32 in the projection 28. It will be understood by a person skilled in the art that other set screws likewise engage corresponding recesses in the projection 28 at ninety degrees relative to adjacent set screws. This provides a stronger connection between the connector 12 and the node 14 and also allows for micro-adjustability of the connector 12 within the recess 44 of the node 14. Relative rotational movement of the connector 12 and the node 14 is restricted by the side edges of the connector 12 pushing against inner walls of recess 44 of the node 14 as shown, for example, for side edge 27 and inner wall 29 in FIG. 12. Relative movement of the connector 12 and the node 14 along and about the x, y and z axes, shown in FIG. 4, is thereby restricted.

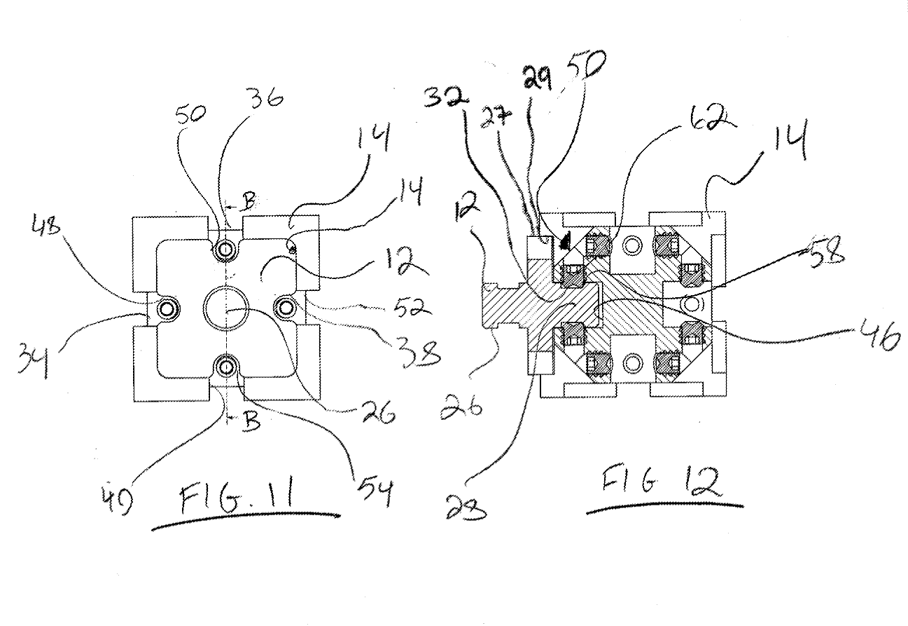

The projection 26 of the connector 12 extends outwardly from the node 14 and allows the connector to engage the first frame member 10 as shown in FIGS. 2 and 4. The connector 12 connects to the first frame member 10 in a substantially identical manner as it connects to the node 14. This is because ends 64 and 66 of the frame member 10 are substantially identical to the side 42 of the node 14 which is best shown in FIGS. 13 to 16. The connector 12 accordingly allows the first frame member 10 to be connected to the node 14 while restricting relative rotational movement as well as movement along the x, y and z axes shown in FIG. 4. Providing frame members 10, 16, 18 of various sizes, as best shown in FIG. 16, together with a plurality of nodes and connectors allows frame assemblies to be readily constructed.

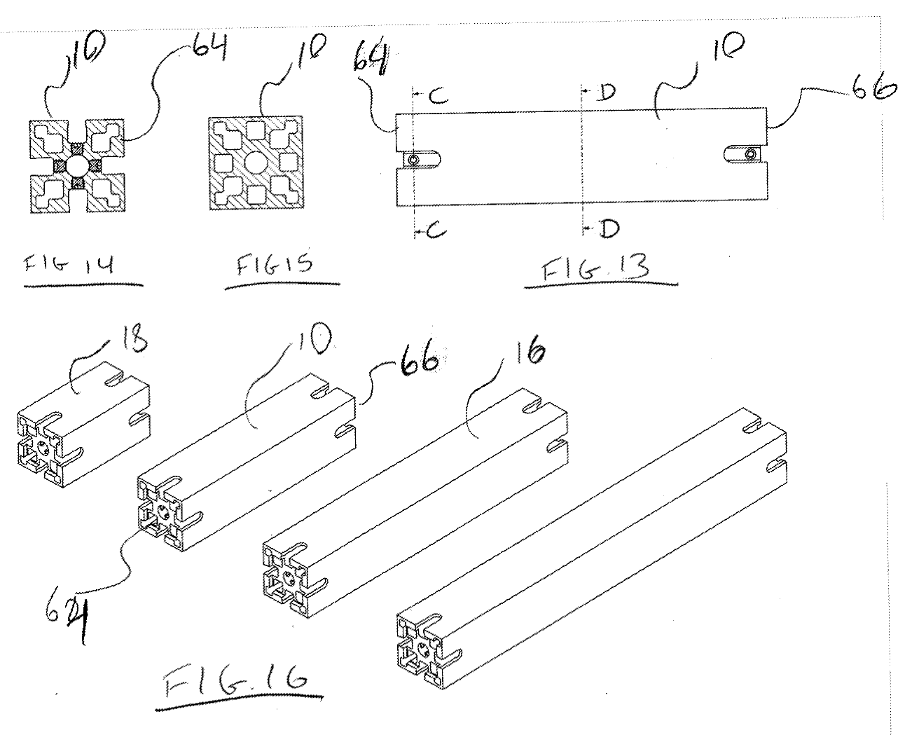

Referring now to FIG. 17, the connector 12 and node 14 are shown together with another component of the modular frame assembly, namely, a hinge member 68. The hinge member 68 includes wings 70 and 72 which are pivotably coupled to on another by a pivot pin 74. The wings 70 and 72 may accordingly pivot relative to one another about an axis 300. The wings 70 and 72 are generally similar in structure to the node 14 with the notable exception that each of the wings 70 and 72 has a respective flange 76 and 78 extending laterally from one side thereof. The pivot pin 74 pivotably couples the wings 70 and 72 at their respective flanges 76 and 78. The remaining sides of the wings 70 and 72 are substantially identical to the side 42 of the node 14 described above. This allows the connector 12 to engage one of the wings 70 and connect the hinge assembly 68 to the node 14 as shown in FIG. 8. It will be understood by a person skilled in the art that relative rotational movement as well as movement along x, y and z axes are restricted. It will also be understood by a person skilled in the art that other components of the assembly may be connected to node 14 or either one of the wings 70 and 72 by another connector.

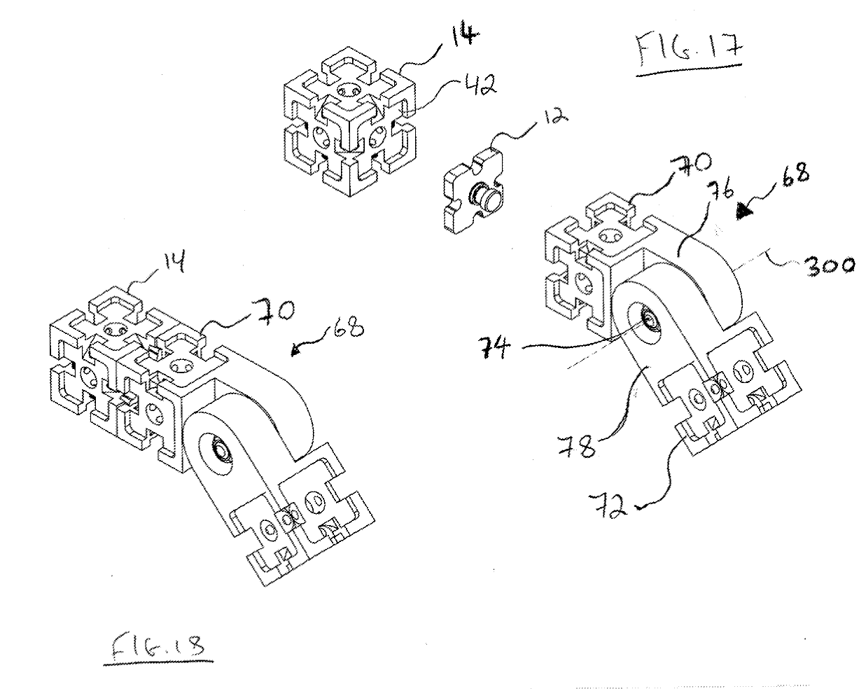

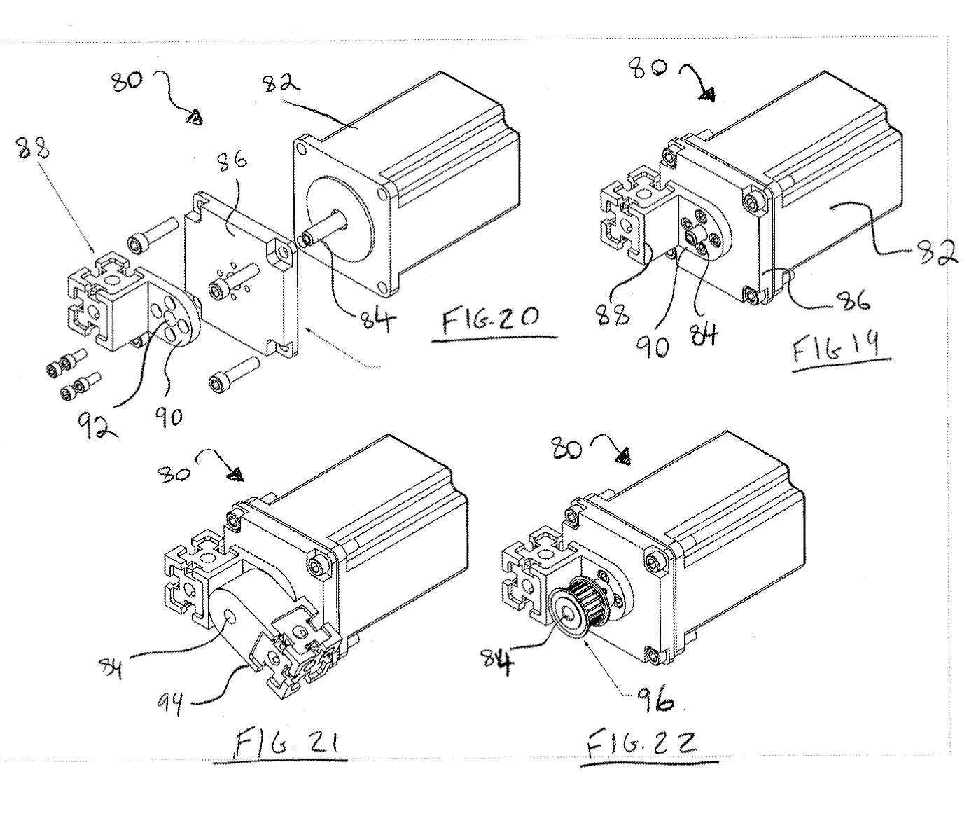

A further component of the modular frame assembly, namely, a driver 80 is shown in FIGS. 19 and 20. The driver 80 includes a motor 82 which imparts rotary motion to a drive shaft 84. There is an adapter plate 86 which allows an adapter 88 to be mounted on the motor 82. The adapter 88 is generally similar in structure to the node 14, shown in FIGS. 8 to 10, with the notable exception that the adapter 88 has a mounting plate 90 extending laterally from one side thereof. The remaining sides of the adapter 88 are substantially identical to the side 42 of the node 14 described above. This allows other components of the modular frame assembly, for example a frame member, to be fixedly connected to the driver 80. The mounting plate 90 of the adapter 88 has an aperture 92 through which the drive shaft 84 extends when the adapter 88 is mounted on the motor 82. The drive shaft 84 may accordingly impart motion to other components of the modular frame assembly as shown in FIGS. 21 and 22.

FIG. 21 shows another adapter 94 mounted on the drive shaft 84 of the driver 80. The drive shaft 84 imparts motion to the adapter 94 and is thereby able to actuate components of the modular frame assembly that may be connected to the adapter 94. FIG. 22 shows a pulley 96 mounted on the drive shaft 84. Accordingly, while the components of the modular frame assembly disclosed herein are generally connected by connectors which restrict relative rotational movement as well as movement along x, y and z axes, the use of components such as hinges and drivers will allow for relative movement of components. The interconnectivity of the components is a result of each component being provided with a side or end configured to engage with a single type of connector.

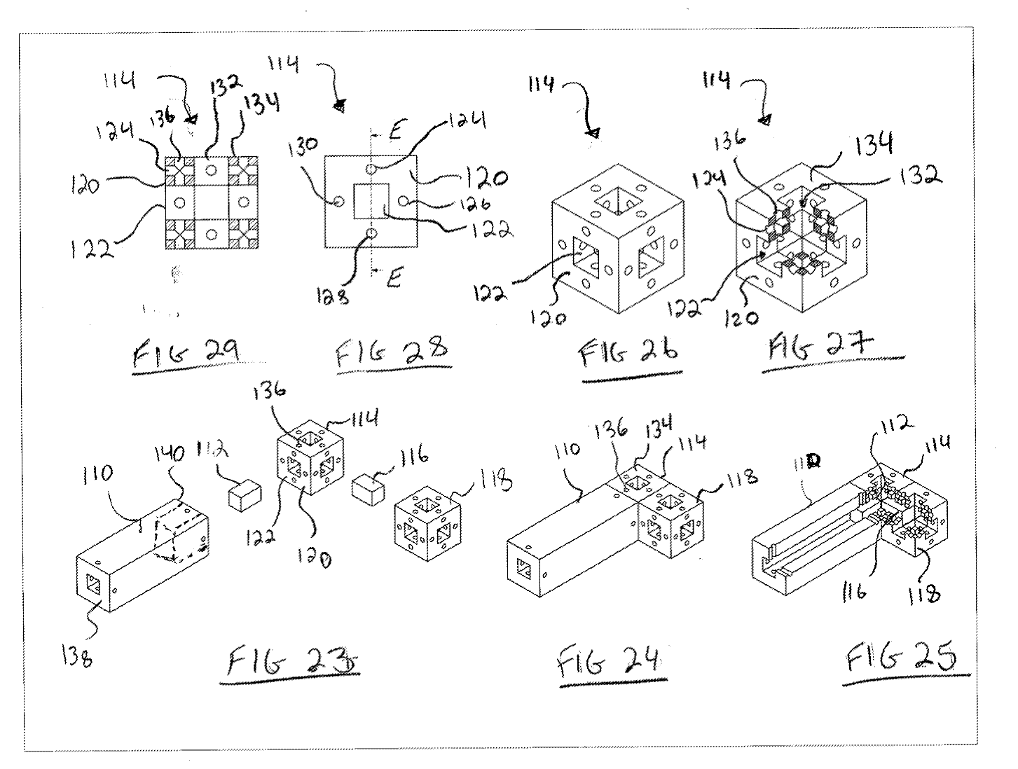

Various components of another modular frame assembly are shown in FIGS. 23 to 29. The components include a frame member 110, a first connector 112, a first node 114, a second connector 116, and a second node 118. As shown in FIGS. 24 and 25, the frame member 110 may be connected to the first node 114 by the first connector 112 and the second node 118 may be connected to the first node 114 by the second connector 118. The first node 114 is shown in greater detail in FIGS. 26 to 29 and, in this example, is generally cuboid in shape. The first node 114 has six substantially identical sides of which one side 120 is best shown. The side 120 has a recess 122 which is configured to receive the first connector 112. There are threaded apertures 124, 126, 128 and 130 disposed about the recess 122. The threaded apertures extend through to corresponding recesses on other sides of the first node 114 as shown, for example, in FIGS. 27 and 29 in which the threaded aperture 124 extends through to a recess 132 on another side 134 of the first node 114. FIG. 29 also shows a threaded aperture 136 which extends from the said another side 134 of the first node 114 to the side 120 of the first node 114 described above. It will be understood by a person skilled in the art that all the sides of the first node 114 have a substantially similar structure and function in a substantially similar manner.

Set screws (not shown) may be used to secure the first connector 112 within the recess 122 when the first connector 112 is received by the recess 122 in the first node 114. For example, a set screw (not shown) may be threaded through the threaded aperture 136 on the said another side 134 of the first node 114. The first connector 112 is received by the frame member 110 in a similar manner because the ends 138 and 140 of the frame member 110 are substantially identical to the side 120 of the first node 114 described above. The first connector 112 accordingly allows the frame member 110 to be connected to the first node 114 while restricting relative movement of the frame member 110 and the first node 114 along and about the x, y and z axes. The second connector 116 likewise connects the second node 118 to the first node 114 as the second node 118 is substantially identical to the first node 114. Other components of the modular frame assembly are also provided with an end or side that is substantially identical to the side 120 of the first node 114. This allows for interconnectivity of the components.

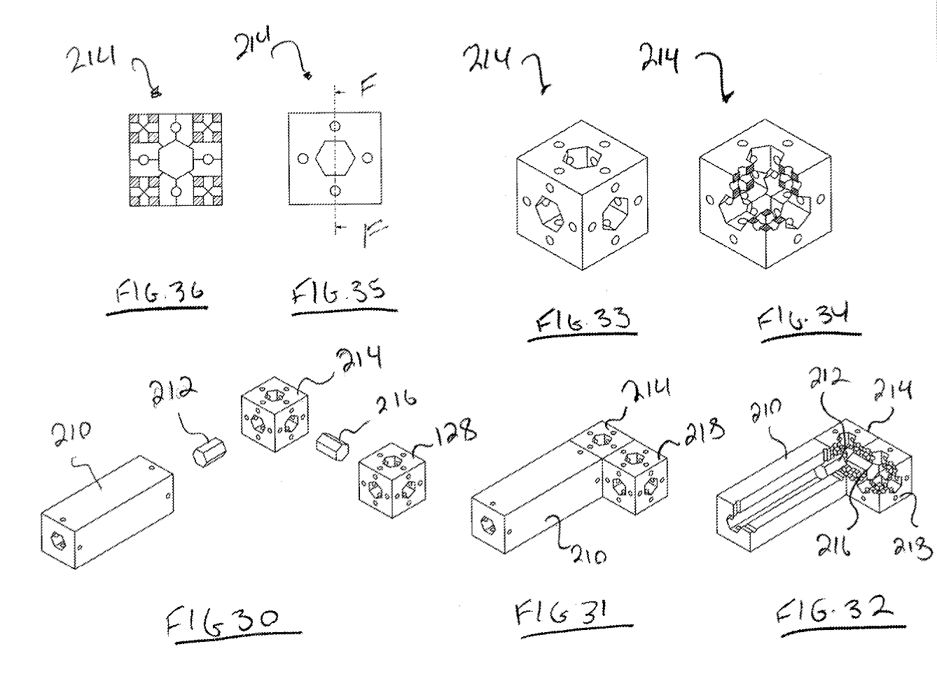

FIGS. 30 to 36 show various components of another modular frame assembly including a frame member 210, a first connector 212, a first node 214, a second connector 216, and a second node 218. The components shown in FIGS. 30 to 36 are generally similar to the components shown in FIGS. 23 to 29 with the notable exception of the shape of the connectors and the recesses in the nodes and ends of the frame member 210.

It will be understood by a person skilled in the art that many of the details provided above are by way of example only, and are not intended to limit the scope of the invention which is to be determined with reference to the following claims.

What is claimed is:

1. A modular frame assembly comprising:
a first frame member and a second frame member; and
a connector, wherein the first frame member is connected to the second frame member by the connector.

2. A modular frame assembly comprising:
a frame member and node; and
a connector, wherein the frame member is connected to the node by the connector.

3. A modular frame assembly comprising:
a first frame member and a second frame member;
a first connector and a second connector; and
a node, wherein the first frame member is connected to the node by the first connector and the second frame member is connected to the node by the second connector.

4. The modular frame assembly as claimed in claim 3 wherein the first frame member is aligned along an x-axis and the second frame member is aligned along a y-axis.

5. The modular frame assembly as claimed in claim 3 further including a third frame member and a third connector, wherein the third frame member is connected to the node by the third connector.

6. The modular frame assembly as claimed in claim 5 wherein the first frame member is aligned along an x-axis, the second frame member is aligned along a y-axis, and the third frame member is aligned along a z-axis.

7. The modular frame assembly as claimed in claim 6 wherein the first frame member, the second frame member, and the third frame member are each an elongate frame member.

8. A modular frame assembly comprising:
a first component;
a second component;
a third component;
a first connector connecting the first component to the second component wherein relative rotation of the first component and the second component as well as relative movement of the first component and the second component along an x-axis a y-axis and a z-axis is restricted; and
a second connector connecting the second component to the third component wherein relative rotation of the second component and the third component as well as relative movement of the second component and the third component along an x-axis, a y-axis and a z-axis is restricted, the first connector and second connector being identical and interchangeable.

9. The modular frame assembly as claimed in claim 8 wherein the first component, the second component, and the third component are unique.

10. A modular frame assembly as claimed in any one of claim 1, 2, 3, or 8 wherein said connectors are received by a recess and relative rotation of said connectors is restricted by a side of said connectors pushing against an inner wall of the recess.
